(19) United States
(12) Patent Application Publication
(10) Pub. No.: US 2012/0304467 A1
(43) Pub. Date: Dec. 6, 2012

(54) Razor Blade Cartridge With Canted Blades

(76) Inventor: James Garden, JR., Jefferson Hills, PA (US)

(21) Appl. No.: 13/474,983

(22) Filed: May 18, 2012

Related U.S. Application Data
(60) Provisional application No. 61/519,924, filed on Jun. 2, 2011.

(51) Int. Cl. B26B 21/22; B26B 21/52; B26B 21/08

(52) U.S. Cl. 30/47; 30/32; 30/50; 30/527

(57) ABSTRACT

Provided is a cartridge for a razor for holding one or more razor blades in a canted orientation including a metal piece formed from sheet metal bent along two or more bend lines running parallel to a longitudinal axis of the metal piece to form a curved top portion, a flat center section, and a curved bottom portion. The cartridge further includes slotted openings cut in linear parallel alignment in the longitudinal direction of the center section of the metal piece and having a sharpened edge such that a razor blade having a first and a second sharpened cutting edge is formed between each set of slotted openings, wherein the slotted openings are canted with respect to the longitudinal axis of the metal piece thereby forming a plurality of canted razor blades. A handle adapted for use with the cartridge is also provided.

### CROSS REFERENCE TO RELATED APPLICATIONS

This application claims benefit of U.S. Provisional Patent Application No. 61/519,924 entitled “Improved Razor Blade Encasements” filed Jun. 2, 2011, which is hereby incorporated by reference in its entirety.

### BACKGROUND OF THE INVENTION

1. Field of the Invention

The present invention is generally directed to a razor for shaving and, more particularly, to an encasement unit, such as a cartridge, for maintaining a plurality of razor blades in a canted orientation.

2. Description of Related Art

For centuries, the act of removing (shaving) facial hair or body hair has been done by careful chopping motions using implements (e.g. razors) with very sharp edges. This method of shaving still is true today no matter if the razor is a barber's straight razor, or if a plurality of razor blades are integrated into the latest iteration of multi-blade cartridges. Usually, the razor's sharp edge(s) is/are brought to bear upon facial hair shafts in a downward (scraping or chopping) motion above the jaw, or an upward or downward (scraping or chopping) motion beneath the jaw such that the longitudinal axis of the razor's edge(s) contacts the shafts of the facial or body hair at an acute angle to the hair shafts, thus chopping through the hair shafts by virtue of the force applied and the sharpness of the razor's edge.

King Camp Gillette patented his safety razor in 1904, giving rise to patents featuring single-edged and double edged razor blades, and the current multi-blade cartridges, all of which place the cutting edges of their blades in a position horizontal relative to the body hair to be cut.

Experience has taught us that chopping utensils and tools like axes need to be sharpened more often than slicing utensils and tools. Experience also has taught us that it is easier to cut bread or meat by using the sharp edge of a knife in a reciprocating, slicing or sawing motion rather than in a forceful chopping motion. Therefore, there is a need for a razor blade which slices rather than chops off facial or body hair.

### SUMMARY OF THE INVENTION

Provided herein is a cartridge, razor, and method of use for shaving which slices rather than chops hair by positioning the razor blades in a canted orientation. According to one non-limiting embodiment of the invention, canting the razor blades' longitudinal axes 70 degrees or more with reference to the horizontal X-axis, or 20 degrees or less with reference to the vertical Y-axis, makes it possible to slice off facial and body hair rather than chopping it off. This slicing action not only makes it easier to shave off hair, it also minimizes nicks and cuts associated with chopping razor blades, and it prolongs the sharpness of razor cutting edges compared to blades that chop.

A man shaving facial hair using both the present invention's canted razor blades and the horizontal razor blades of current razor blade cartridges can literally hear the difference between the two types in the same way that he can “hear” the sounds when he is chewing food in his mouth—especially crunchy food. The chopping of facial hair of horizontal blades affixed in current razor blade cartridges generates a substantially higher intensity of sound compared to the sound of the slicing action of the current invention. This difference in sound intensity demonstrates the ease and efficacy of slicing facial hair off over chopping or scraping it off.

A vertical chopping motion is described as a forceful motion acting upon a cutting edge of a cutting implement; the forceful motion being simultaneously parallel to the vertical axis and perpendicular to the longitudinal axis of the cutting edge. Upon contact with an object that lends itself to cutting, the cutting edge causes a limited-depth opening or incision in the object, or it may force its way all the way through the object. A chopping cut is accomplished both by the degree of force imparted to the cutting edge of a cutting implement and by the ability of the sharp cutting edge to separate molecules in the object being cut.

Slicing is a cutting action that can be a unidirectional sliding or a reciprocating motion along the surface of the object being cut. The slicing action can take place more or less in a single plane in directions both parallel to and perpendicular to the longitudinal axis of the cutting edge of a cutting implement while simultaneously cutting into or through an object at acute angles of 0 degrees-90 degrees to the object's longitudinal axis.

A dull-edged razor blade will resist cutting facial hair when the razor is used in a chopping manner, whereas that same dull-edged blade will slice facial hair with much less resistance, attesting to the advantage of slicing over chopping.

Accordingly, the aspects of the claimed invention are as follows.

1. To provide for the removal of facial or body hair in a slicing action rather than a chopping action.

2. To provide the necessary means and configurations of razor blade encasements for encasing an encasement support.

3. To provide encasements that will fit over a provided encasement support that is attached to a generic non-slip handle.

4. To extend the life of a razor's cutting edges by providing the means of slicing off facial or body hair rather than chopping off the hair.

5. To provide a more economical means and configuration of providing multiple blades that are contained on a single piece of metal, or other suitable material, thus saving the time-consuming and expense of manufacturing and assembling a razor unit made from multiple parts. The advantage of providing a plurality of blades, contained on and made from, a single piece of metal or other suitable material, does not preclude the manufacture of a razor blade encasement that contains a plurality of individually-manufactured parts and blades that are to be assembled and canted into the canted configurations as described and shown herein.

6. To provide an improvement over current razor blades and razor blade cartridges such that the longitudinal axis of the cutting edges are steeply canted from the horizontal axis such that a slicing action of facial or body hair is accomplished.

7. To provide an improvement over current razor blades and razor blade cartridges by slicing facial or body hair such that the plane of the canted cutting edges are parallel or are within three degrees of being parallel to the skin area being shaved, rather than at angles greater than three degrees as is found on virtually every razor blade cartridge on the market today.

8. To provide an easier and less painful method of removing body hair in preparation for surgery, since frequently it is necessary to shave off body hair without using soap and water to soften the hair. Although some razor blade manufacturers recommend that one should shave facial beard “with the grain”, meaning in the direction of hair growth, the slicing action of the canted blades facilitates the effortless removal of facial or body hair irrespective of the direction of hair growth.

9. To provide a razor that is safe to use.

In accordance with an embodiment of the present invention, a razor blade cartridge having one or more canted razor blades includes a metal piece bent to form a housing having a top portion, a flat section, and a curved portion and two or more slotted openings cut in linear parallel alignment in a longitudinal direction of the center section of the metal piece and having a sharpened edge such that a razor blade having a first and a second sharpened cutting edge is formed between each set of slotted openings. The slotted openings are canted with respect to a longitudinal axis of the metal piece.

In certain configurations, the metal sheet is formed from a rust resistant alloy. In addition, the slotted openings may be canted at an angle of between about 70 and 89 degrees with respect to a longitudinal axis of the metal piece thereby forming a plurality of canted razor blades. The plurality of canted razor blades may be aligned to overlap such that a vertical line running downward from a highest point of a cutting edge of one razor blade will overlap a lower point of the cutting edge of an adjacent razor blade. In addition, the sharpened cutting edge of the razor blade may be hollow-ground sharpened, or wherein the sharpened cutting edge is tapered.

In certain configurations, the cartridge further includes one or more trimming blocks having a blade running parallel to the longitudinal axis of the cartridge for trimming longer hair such as the sideburns of a user. Optionally, the trimming block is brought into contact with the surface to be shaved by placing the top or bottom curved portion of the metal piece on a surface and rotating the cartridge toward an area to be shaved thereby bringing the blade of the trimming block in contact with the area to be shaved.

In accordance with a further embodiment of the present invention, a razor and cartridge having one or more canted razor blades includes a cartridge having a metal piece bent to form a housing having a top portion, a flat section, and a curved portion and two or more slotted openings cut in linear parallel alignment in a longitudinal direction of the center section of the metal piece and having a sharpened edge such that a razor blade having a first and a second sharpened cutting edge is formed between each set of slotted openings. The slotted openings are canted with respect to a longitudinal axis of the metal piece thereby forming one or more canted razor blades. The razor further includes an encasement support which is received within a cavity formed by the curved top and curved bottom portions of the metal piece of the cartridge such that the cartridge surrounds and is supported by the encasement support and a handle extending from the encasement support allowing a user to hold and guide the razor while in use.

In certain configurations, the razor further includes an axle located between the encasement support and the handle for allowing the cartridge to pivot during shaving. The cartridge may be removable from the encasement support. Furthermore, when the cartridge is removable, the cartridge is also capable of being rotated 180 degrees and reinserted to the encasement support in an upside down orientation so that, in use, the second cutting edges of the razor blades are used for shaving.

In accordance with another embodiment of the present invention, a cartridge for holding one or more razor blades in a canted orientation includes a frame having a front face, a rear face, a top end, and a bottom end, and a sunken structure formed within the front face and one or more sets of locating notches on the front face of the frame located adjacent to the sunken structure, wherein each set of two notches is configured to hold a razor blade across the sunken structure in a canted position with respect to a longitudinal axis of the frame.

In certain configurations, the one or more sets of locating notches are configured to hold the razor blade at an angle of between about 70 and 89 degrees with respect to the longitudinal axis of the cartridge. Optionally, the one or more sets of locating notches are configured to hold one or more razor blades in parallel and linear alignment forming equidistant spaces between the razor blades. The equidistant spaces between said razor blades may be wider than the width of the razor blades. In addition, the one or more sets of locating notches may be configured to hold the razor blades such that the cutting edge of the razor blade is bent upwards a maximum of one degree or a maximum equal to the thickness of said razor blade.

In certain configurations, the cartridge further includes one or more razor blades having a top end and a bottom end wherein the top end and bottom end of the razor blade are connected to corresponding locating notches of the frame. The cartridge may also further include a cementing locking piece for holding in a sealing engagement of the one or more razor blades to the locating notches.

These and other features and characteristics of the present invention, as well as the methods of operation and functions of the related elements of structures, will become more apparent upon consideration of the following description and the appended claims with reference to the accompanying drawings, all of which form a part of this specification, wherein like reference numerals designate corresponding parts in the various Figures. As used in the specification and the claims, the singular form of “a”, “an”, and “the” include plural referents unless the context clearly dictates otherwise.

### BRIEF DESCRIPTION OF THE DRAWINGS

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

FIG. 1 is a front view of a razor blade encasement in accordance with an embodiment of the present invention before bending into an encasement configuration as shown in FIG. 3A;

FIG. 2 is a front view of a razor blade encasement in accordance with a further embodiment of the present invention;

FIG. 2A is a section view of typical blades of the encasement of FIG. 2;

FIG. 3A is an end view of the razor blade encasement of FIG. 1;

FIG. 3B is an end view of an encasement support with an integral non-slip handle in accordance with an embodiment of the present invention;

FIG. 3C is a top view of the encasement support with the integral non-slip handle of FIG. 3B;

FIG. 4A is a front view of a slotted opening of the razor blade encasement of FIG. 1 with a sectional cutting plane;

FIG. 4B is a sectional view of a canted razor blade with hollow-ground sharpening in accordance with an embodiment of the present invention;

FIG. 4C is a sectional view of a canted razor blade with tapered sharpening in accordance with a further embodiment of the present invention;

FIG. 5 is a front view of a razor blade encasement in accordance with a further embodiment of the present invention;

FIG. 6 is an end view and cross-sectional view of the razor blade encasement of FIG. 5;

FIG. 7 is a front view of the encasement framework of the razor blade encasement of FIG. 5;

FIG. 8 is an end view and cross-sectional view of the encasement framework of FIG. 7;

FIG. 9 is a top view of a razor blade in accordance with an embodiment of the present invention;

FIG. 10 is a side view of the razor blade of FIG. 9;

FIG. 11 is an end view of the razor blade of FIG. 9;

FIG. 12 is a schematic drawing which illustrates the positioning of the razor blades of FIG. 9 into locating notches of the razor blade encasement of FIG. 5;

FIG. 13 is a top view of a locking piece of the razor blade encasement of FIG. 5;

FIG. 13A is an end view of the locking piece of FIG. 13;

FIG. 14 is a tool for removing encasements from the encasement support of FIG. 3B;

FIG. 15 is a schematic drawing which demonstrates the slicing action of the cutting edge of the canted razor blade of FIG. 9;

FIG. 16 is a schematic drawing that illustrates the distribution of slicing force using a razor blade with a 10 degree cant from vertical; and

FIG. 17 is a schematic drawing that illustrates the force distribution of chopping using a razor blade with a 60 degree cant from vertical.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing Figures. However, it is to be understood that the invention may assume various alternative variations, except where expressly specified to the contrary. It is also to be understood that the specific devices illustrated in the attached drawings, and described in the following specification are simply exemplary embodiments of the invention. Hence, specific dimensions and other physical characteristics related to the embodiments disclosed herein are not to be considered as limiting.

Initially, it is noted that reference numbers 26, 33, 36, 37, 38, 44, 76, 99, and bend lines A-A, B-B, C-C, D-D, E-E, and F-F, refer to similar parts or areas of razor blade encasements 25, 25A, and 125. Horizontal reference line 20-20, vertical reference line 21-21, and longitudinal axis lines 22-22 apply to razor blade encasements 25, 25A, and 125.

According to one non-limiting embodiment, razor blade encasements 125, 25, and 25A are encasements with parallel, canted razor blades 134 and 34 respectively, whose longitudinal axes 22-22 can be canted at any angle from vertical reference line 21-21 to horizontal reference line 20-20, in a clockwise or counter-clockwise direction with reference to vertical reference line 21-21. It is recognized that the canting angle of canted razor blades 34 must deviate, however slightly, from vertical reference line 21-21, or horizontal reference line 20-20, in order to slice body hair.

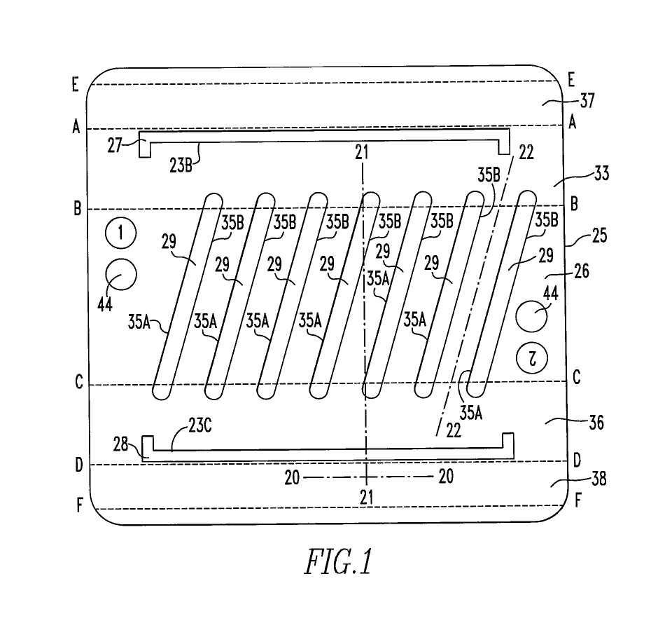

Razor blade encasement 125 includes individual canted metal blades 134. The longitudinal axes of blades 134 can be canted from 1 degree to 89 degrees from horizontal reference line 20-20, shown in the drawings. The preferred range of canting is between 70 degrees and 89 degrees with reference to, and as measured from, horizontal reference line 20-20, shown in FIG. 1. The canting can also be measured from vertical reference line 21-21, also shown in FIG. 1. The preferred range of deviation from vertical reference line 21-21 is from 1 to 20 degrees.

The assembly and affixation of canted razor blades 134 takes place during a 3-dimensional printing process that uses a hardening-type material such as plastic, or razor blade encasement 125 may be made of individual canted blades 134 that are assembled and affixed mechanically in the same manner of current razor blade cartridges.

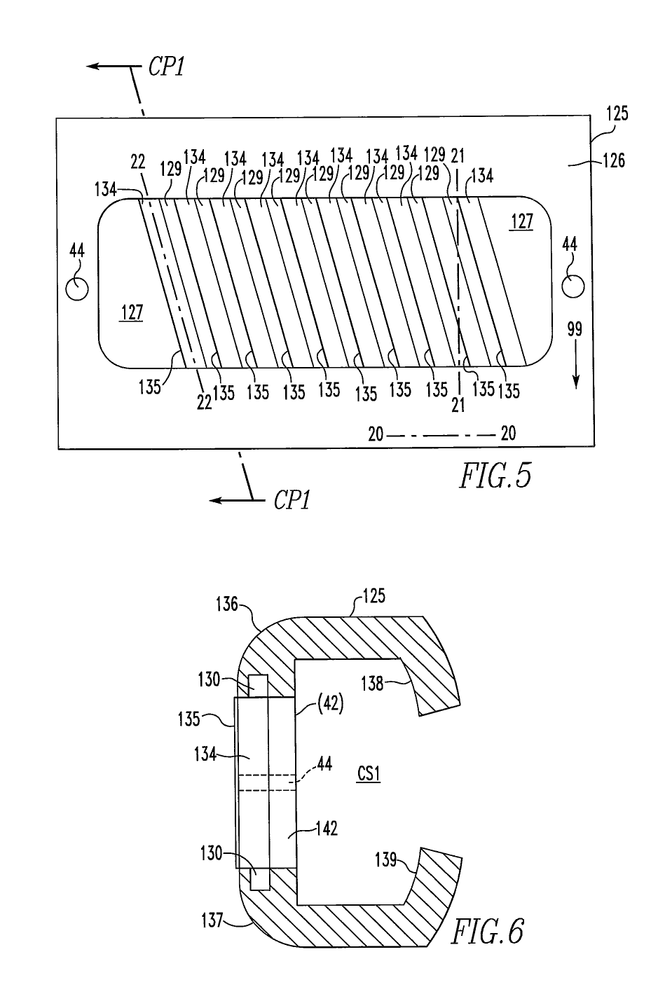

Razor blade encasement 125 is assembled by installing individual razor blades 134 in their snug-fit locating notches 143 on encasement framework 123. When all blades are installed, the blades are sealed in place by the layering action of a 3-dimensional printer, if that is the method of manufacture, or the blades are sealed in place by gluing or cementing locking piece 131, which permits a rounded surface, as shown in plan view by FIG. 5, and in profile by FIG. 6.

Razor blade encasement 25 preferably is to be made from a single piece of non-rusting alloyed sheet metal, but can be made from unalloyed metal or any other material suitable for making razor blades. The blades may be platinum/chromium coated and coated with performance enhancers such as poly tetra fluoro-ethylene coating or the like.

History has shown, for instance, that the iron ore from which famed Damascus swords were made unknowingly contained a small percentage—0.02%—of vanadium. Vanadium made the swords rustproof, and accounted for their strength, durability, relatively light weight, and their ability to hold a lasting sharp edge. Currently, vanadium is alloyed with steel in the range of 0.1% to 3.0%.

If encasement 25 is made from one piece of material, then during, or subsequent to the manufacturing processes, cutting edges 35 optionally may be bent uniformly outwards such that cutting edges protrude slightly towards the area to be shaved by an amount not to exceed the thickness of the blade material.

Canted razor blades 134 as shown in FIG. 6 are to be parallel to each other. Canted razor blades 34 are also to be parallel with each other.

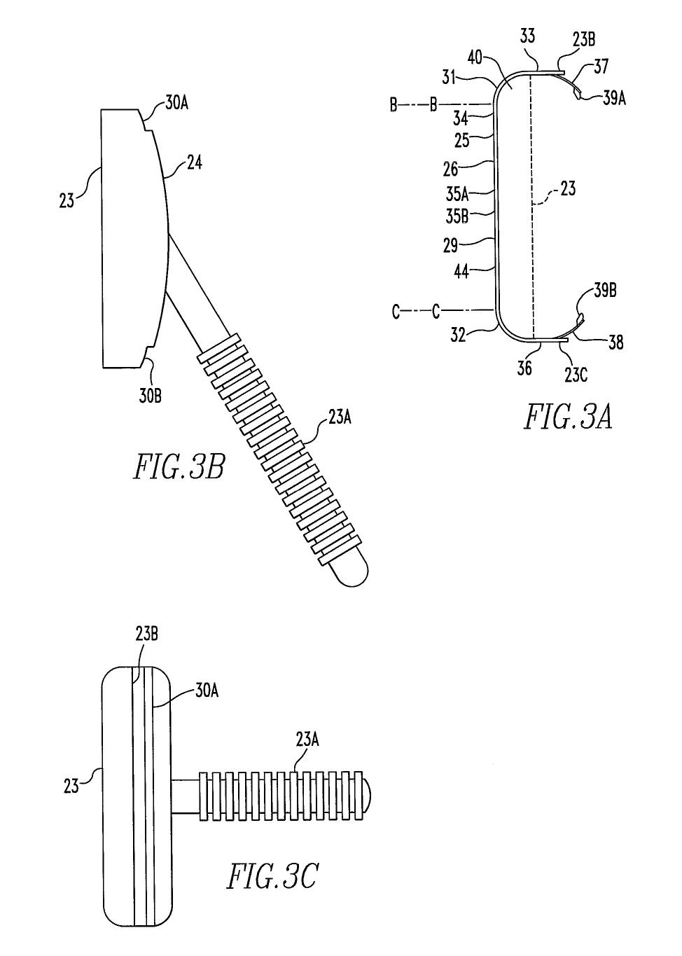

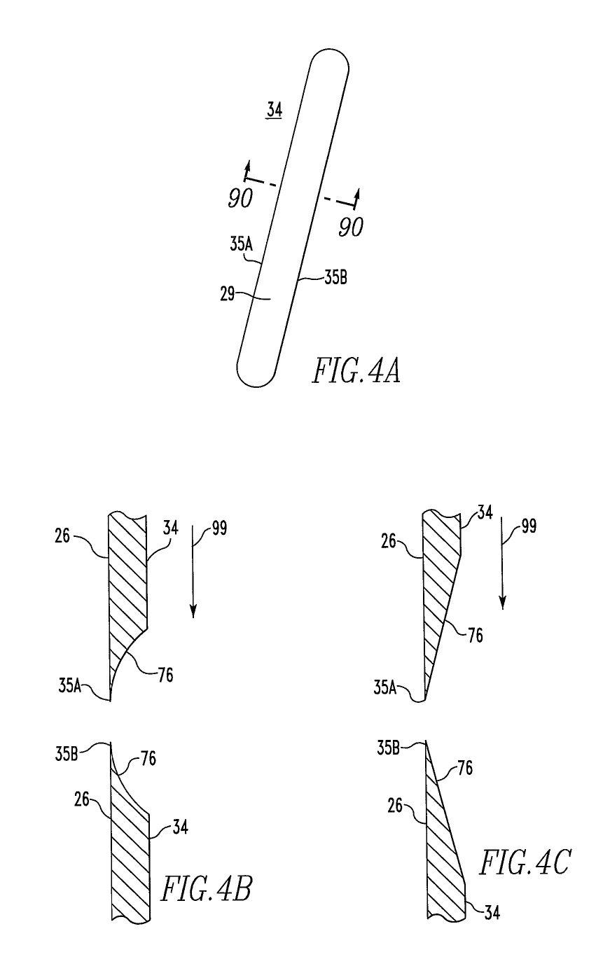

Razor blade encasements 25 and 125 are designed to slide onto or envelop encasement support 23. Integral with encasement support 23 is non-slip handle 23A. (See FIG. 3B). Razor blade encasement 25, with encircled numeral 1 upright, (See FIG. 1), slides over the end of encasement support 23, enveloping the front, top, bottom, and part of the back of encasement support 23. Encasement 25 then is placed against a face or leg, for instance, in such operative orientation that obverse side 26 touches the skin, causing facial or body hair to protrude through slotted openings 29. By moving encasement support 23, with razor blade encasement 25 attached in an operative position, in a direction indicated by directional line 99 (See FIG. 4B or 4C), from top to bottom, cutting edges 35 of canted blades 34 slice off hair shafts where they protrude through slotted openings 29. The slicing action makes it easier to shave off hair no matter the direction of growth of the hair, and said slicing action also prolongs the sharpness of the razor cutting edges, compared to blades that chop. If cutting edge 35 is viewed as the front edge of any canted blade 34, then a vertical reference line 21-21, drawn at a right angle to horizontal reference line 20-20, drawn down from the highest point of any cutting edge 35 between bend line B-B and bend line C-C will overlap a lower point of the cutting edge 35 of the adjacent cutting edge 35 in front of it, thus insuring that two cutting edges 35 shave the area to be shaved. (See FIG. 1).

The same overlap applies to cutting edges 35 when razor blade encasement 25 is removed from encasement support 23, turned upside down, and reinstalled over encasement support 23, thus exposing a new set of canted cutting edges 35, with the encircled number 2 displayed as right-side-up.

Using razor blade encasement 25 as an example, the purpose of top curve 31 and bottom curve 32, as well as retainer strips 37 and 38, (See FIG. 3A), are to hold encasement support 23 firmly in place when razor blade encasement 25 is slid over encasement support 23. The process of bending results in top curve 31, and bottom curve 32, and creates a notched configuration between canted razor blades 34 and slotted openings 29. The curves 31 and 32 also establish cavity 40 between razor blade encasement 25 and encasement support 23, thus leaving room for body hair to enter slotted openings 29 through bottom curve 32, prior to being sliced and rinsed off. The notched cavity between canted razor blades 34 and slotted openings 29 can be visualized by viewing the area between dashed lines A-A and B-B, which will become top surface 33 after bending. The same description applies to the area between dashed lines C-C and D-D, which, after bending, becomes bottom surface 36. (See FIG. 1).

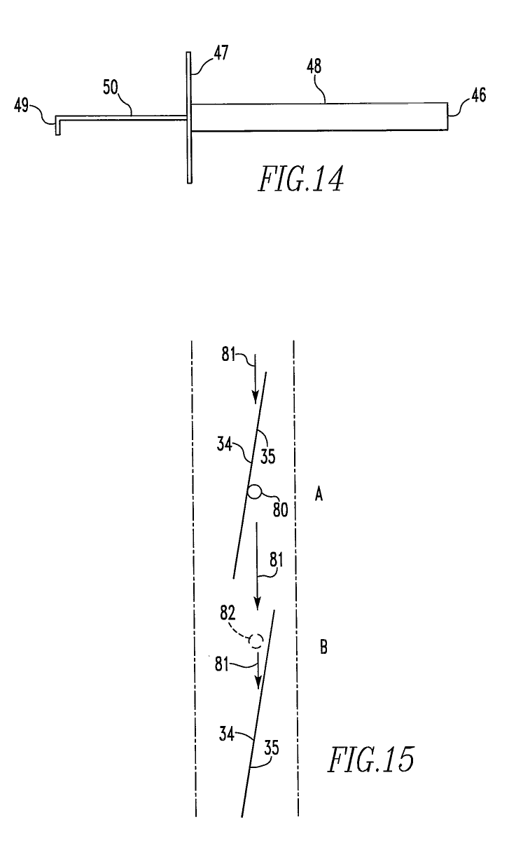

Razor blade encasement 25 is removed from encasement support 23 with the help of extraction tool 46, shown in FIG. 14. Hook 49 of extraction tool 46 is inserted into either dog hole 44, in razor blade encasement 25. The operator's forefinger and middle finger are bent around finger support 47 attached to handle 48, which is held in the operator's hand. Razor blade encasement 25 then is safely pulled off encasement support 23. Razor blade encasement 25 then can be turned upside down, (bringing encircled number 2 upright), and replaced over encasement support 23, thus exposing a new set of canted cutting edges 35B that are thus brought into operative position. This double-duty is possible since the bottom half of razor blade encasement 25 is made as a mirror image of the top half.

Dog holes 44, shown in FIG. 1, also function as a means of positioning and holding in place razor blade encasement 25 with gripping machine dogs during manufacture.

As mentioned above, razor blade encasements 125 and 25 are the preferred embodiments of the present invention and are designed to encase encasement support 23. Encasement support 23 and integral non-slip handle 23A are molded together as one piece using a sturdy plastic, metal, or other suitable material. Of course, encasement support 23 may be made to pivot on an axle built into the handle. Trimmer blades 23B and 23C can be formed and sharpened during manufacture. Trimmer blades 23B and 23C can be used to trim a man's sideburn, for instance.

Curved surface 24, as shown in FIG. 3B, combined with the curved surfaces of retainer strips 37 and 38, enables a shaver to control the point of contact of trimmer blade 23B (or trimmer blade 23C) with the shaver's sideburn, by “rolling” the curved surfaces 24 and 37 (or 38) upward until contact is made at the desired point with the beard of the sideburn. Notch 30A and notch 30B allow retainer strips 37 and 38 to fit against encasement support 23 such that the arc of curved surface 24 is continued smoothly by retainer strips 37 and 38.

Razor blade encasement 125 is assembled using multiple, individual blades 134, but its canted configuration is identical to that of razor blade encasements 25 and 25A.

FIG. 1 displays a plan view of razor blade encasement 25 as it would appear after being manufactured from one piece of metal, and before bending and shaping into a finished razor blade encasement 25. A plurality of canted blades 34 is to be configured by manufacturing processes that cut slotted openings 29 without leaving burrs, resulting in clean and smooth slotted openings 29 between canted blades 34 preparatory to blade sharpening, if blade sharpening was not done during the cutting of slotted openings 29.

The plan view of FIG. 1 shows the face side—the obverse side 26—of the flat piece of metal from which slotted openings 29 are to be cut before bending. Cutting edges 35A and 35B of canted blades 34 are to be sharpened from the reverse side 76 of canted blades 34, as shown in FIGS. 4B and 4C, towards the obverse side 26, from the upper part of slotted openings 29 at dashed line B-B to the lower part of slotted openings 29 at dashed line C-C. In that way, cutting edges 35A and 35B will be in the same plane as obverse side 26. Cutting edges 35A will slice facial or body hair, but cutting edges 35B will not slice hair unless and until razor blade encasement 25 is pulled off encasement support 23, is turned upside down, and is replaced over encasement support 23. Thus, a new set of blades—cutting edges 35B—will replace cutting edges 35A when cutting edges 35A are no longer sharp.

Dashed line B-B establishes where top curve 31 begins to bend backward from obverse side 26, and dashed line C-C establishes where bottom curve 32 begins to bend backward from obverse side 26. See FIG. 3A for an end view of top curve 31 and bottom curve 32. Top surface 33 and bottom surface 36 may be bent approximately 90 degrees backwards from obverse side 26, but may be bent more than or less than 90 degrees backward from obverse side 26 by an amount to be determined by the manufacturer. Top surface 33 and bottom surface 36 are equal in width and depth.

During, or subsequent to the manufacturing processes, the cutting edges 35A and 35B optionally may be evenly and uniformly bent such that cutting edges 35A and 35B protrude slightly towards the area to be shaved by an amount not to exceed the thickness of the blade material. Stated differently, if bent as described in the previous sentence, cutting edges 35A and 35B of canted blades 34, and not the vertical contact surfaces, would be the first part of razor blade encasement 25 to touch body or facial hair that is intended to be sliced off.

The longitudinal axes 22-22 of canted blades 34 as shown in FIG. 1 are canted acutely downward at an angle of 15 degrees from vertical line 21-21, but can be canted at 10 degrees easily while maintaining the overlap function.

Successive canted blades 34 in razor blade encasement 25 are parallel to each other. The widths of canted blades 34 are wider than slotted openings 29 to accommodate sharpened edges 35A and 35B on both sides of the blades. The canting angle of the canted blades 34 can be less or more from the vertical line than that shown in FIG. 1. The less the canting angle is from the vertical line, without becoming vertical, the easier the slicing action becomes.

The canted, slotted openings 29, working in concert with top curve 31 and bottom curve 32, enable an unobstructed, smooth gliding action of cutting edges 35 to slice off facial or body hair, and for the shaved hair to be rinsed away.

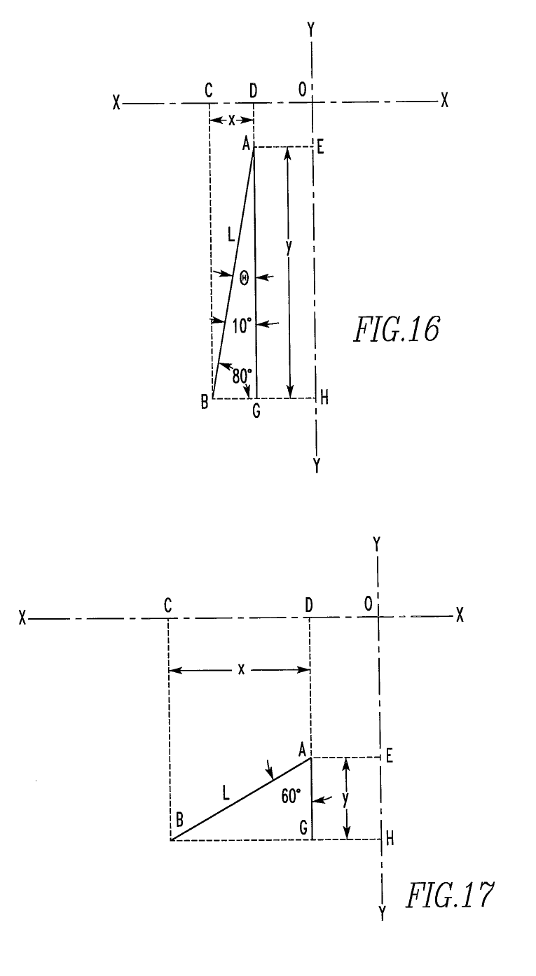

Furthermore, bottom curve 32 acts as a safety guard. When shaving facial or body hair, bottom curve 32 is brought into contact with the operator's skin without danger of cutting that skin. Only by rolling or rotating obverse side 26 towards the skin do cutting edges 35A of canted razor blades 34 come in contact with the area to be shaved. The same safety conditions apply when razor blade encasement 25 is removed from encasement support 23, is turned upside down, and is re-inserted onto encasement support 23 to bring top curve 31 (now assuming the role of bottom curve 32) and cutting edges 35B into an operative position. The more that the canting angle deviates from the vertical line, down to 45 degrees, the more that cutting edges 35 tend to chop rather than slice, although the slicing action still dominates. (See FIG. 16). At 45 degrees, slicing and chopping actions are equal. A deviation greater than forty-five degrees from the vertical line results in more chop than slice. (See FIG. 17). Top curve 31 and bottom curve 32 extend over the full width of the area covered by canted blades 34 and obverse side 26 of razor blade encasement 25.

With continued reference to FIG. 1, a front view (the obverse side 26) of razor blade encasement 25 is depicted as it would appear after being cut from one piece of flat sheet metal, and before bending and shaping into finished razor blade encasement 25. A plurality of canted blades 34 is to be configured by manufacturing processes such as laser machining that remove sections of metal, resulting in slotted openings 29 between blades 34. The thickness of the sheet metal must be such that it will not bend during shaving, and it must be thick enough to be sharpened, resulting in cutting edges 35A and 35B

Alternatively, a razor blade encasement similar to encasement 25 can be assembled using a plurality of individual canted blades 134 and necessary supporting parts, as disclosed by razor blade encasement 125 in FIG. 5.

Cutting edges 35A and 35B of canted blades 34 are to be sharpened from reverse side 76 towards the front (the obverse side 26), and sharpened from the upper part of slotted openings 29 at dashed line B-B to the lower part of slotted openings 29 at dashed line C-C. (See FIGS. 4A, 4B, and 4C).

Dashed lines A-A and D-D are bend lines that define where retainer strips 37 and 38 begin. The function of retainer strips 37 and 38 is to hold encasement support 23 securely in place against top curve 31 and bottom curve 32, as shown in FIG. 3A.

Top curve 31 and bottom curve 32 create a notched configuration between canted blades 34 and slotted openings 29 when bent, and create cavity 40 between canted blades 34 and encasement support 23. (See FIG. 3A for cavity 40).

Dashed lines E-E and F-F show respectfully where single-hem edges 39A and 39B (see FIG. 3A) are bent. Single-hem edges 39A and 39B facilitate the positioning of razor encasement 25 over encasement support 23.

Successive canted blades 34 are parallel to each other. The widths of canted blades 34 are wider than the widths of slotted openings 29 to accommodate sharpened edges 35A and 35B. The canting angle of the canted blades 34 can be less or more from the vertical line than that shown in FIG. 1, since the smaller the angle from vertical reference line 21-21, the better and easier is the slicing action.

Dog holes 44 function as a means of removing razor blade encasement 25 from encasement support 23, using extraction tool 46. (See FIG. 14). Dog holes 44 also enable the positioning and holding in place of razor blade encasement 25 during manufacture.

The encircled numbers 1 and 2 (See FIG. 1) are ink stamped or otherwise indicated on the surface of obverse side 26 of razor blade encasement 25 for the convenience of the person who will use razor blade encasement 25 to shave. When a person slides a new razor blade encasement 25 onto encasement support 23, the encircled number 1 should be upright, thus putting all cutting edges 35A into operative position for shaving. When it is time to use a new set of blades because of dullness, the person uses extraction tool 46 to remove razor blade encasement 25 from encasement support 23. That person then turns razor blade encasement 25 upside down, slides encasement 25 onto encasement support 23, with encircled number 2 right-side up, thus bringing all cutting edges 35B into operative position.

Top surface cutout 27 and bottom surface cutout 28 are openings cut out of razor blade encasement 25 during manufacture. They are identical in size, shape, and relative position. Their purpose is to define the size and shape of trimming blades 23B and 23C, and to allow the optimum angle by which the trimming blades 23B, 23C deviate from the bend angles of retainer strips 37 and 38. Bottom surface cutout 28 becomes a top surface cutout when razor blade encasement 25 is removed from encasement support 23, is turned upside down, and is re-inserted on encasement support 23. As with cutting edges 35A and 35B, trimming blades 23B and 23C are to be sharpened from the reverse side 76 of razor blade encasement 25 towards the obverse side 26.

During the process of shaving, facial or body hair protrudes through slotted openings 29, thus making possible slicing off facial or body hair by cutting edges 35A or 35B. The slicing action makes it easier to shave off hair no matter the direction of growth of the hair, and also prolongs the sharpness of razor cutting edges, compared to blades that chop.

Vertical reference line 21-21 establishes that the top of cutting edges 35A of canted razor blades 34 overlap the area sliced by the bottom of the cutting edges 35A in front of the adjacent canted razor blades 34. The longitudinal axes 22-22 of canted blades 34 as shown in FIG. 1 are canted acutely downward at an angle of 15 degrees from vertical reference line 21-21, but can be canted at a range of many angles while retaining the overlap function.

Bottom curve 32, obverse side 26, and slotted openings 29 enable an unobstructed, smooth gliding action of cutting edges 35A or 35B of canted blades 34 to slice off facial or body hair, and for the accumulated shaved hair to be rinsed away from cavity 40.

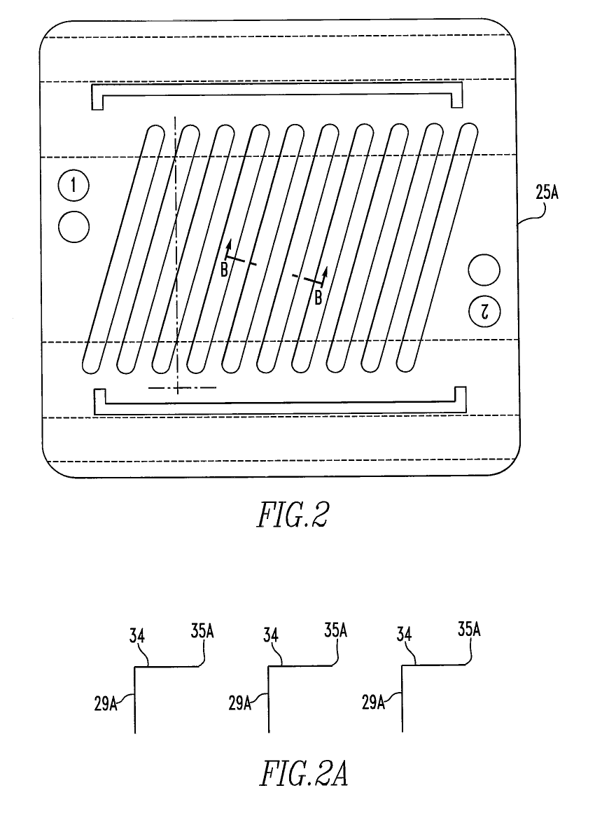

With reference now to FIG. 2, razor blade encasement 25A is depicted and is identical to razor blade encasement 25 in FIG. 1, except for the blades. Whereas razor blade encasement 25 shows seven double-edged blades 35A and 35B, razor blade encasement 25A shows ten single-edged blades 35A only. Razor blade encasement 25A cannot be turned upside down to expose a new set of cutting edges. Metal normally removed to make slotted openings 29 is not completely removed. Rather, that which would become cutting edge 35B of razor blade encasement 25 is not cut, but is retained, and bent 90 degrees away from obverse side 26 towards reverse side 76, between bend lines B-B and C-C, thus becoming structural beam 29A as shown in FIG. 2A. Structural beam 29A supports canted blades 34, preventing flexure when shaving.

With reference now to FIG. 2A, a section of blades of razor blade encasement 25A is depicted and is representative of all canted blades 34 and all cutting edges 35A of razor blade encasement 25A.

With reference now to FIG. 3A, an end view of razor blade encasement 25 is depicted, made from one piece of metal or other suitable material, as it would appear with bends and curves as specified above, ready for sliding over and enveloping encasement support 23. A dashed line labeled 29A shows where structural beams 29A on each canted razor blade 34 of razor blade encasement 25A would extend into encasement support 23 when enveloping encasement support 23.

This cartridge, shown in FIG. 3A, is a variation of razor cartridges currently in use, where cartridges are attached to handles by various mechanical means. Single-hem edge 39A is shown at the end of retainer strip 37, and single-hem edge 39B is shown at the end of retainer strip 38. Single-hem edges 39A and 39B, in conjunction with retainer strips 37 and 38, serve two main purposes: (1) to provide a smooth, curved surface leading to trimmer blade 23B; and (2) to press encasement support 23 tightly against razor blade encasement 25 at the beginning of top curve 31 and at the beginning of bottom curve 32. Thus, cavity 40 is formed between obverse surface 26 on razor blade encasement 25, and a front surface 42 of encasement support 23. The front surface 42 of encasement support 23 is represented by a dashed vertical line in FIG. 3A.

The function of cavity 40 is to accept body hair between razor blade encasement 25 and front surface 42 of encasement support 23, and to facilitate rinsing away shaved hair. The distance between line B-B and line C-C defines the effective vertical area of the cutting edges 35A and 35B.

Note that top curve 31, bottom curve 32, retainer strip 37, and retainer strip 38 work in concert to keep razor blade encasement 25 fixed in an operative position. Trimmer blades 23B and 23C are shown. Note also that canted razor blades 34, cutting edges 35A, 35B, obverse surface 26, slotted openings 29, and dog holes 44 are all in the same plane.

With reference now to FIG. 3B, a side view of encasement support 23, non-slip handle 23A, notches 30A and 30B, front surface 42, and curved surface 24 are depicted. Encasement support 23 is to be used for razor blade encasements 25, 25A, and 125. Integral non-slip handle 23A is drawn as a generic handle. Any handle, especially an articulated handle, from expired patents can be used as a handle for encasement support 23. When cast or molded integrally with encasement support 23, handle 23A can be smooth, and covered later with a rubber or plastic tube configured with finger-gripping designs.

With reference now to FIG. 3C, a top view of encasement support 23 with integral non-slip handle 23A is depicted. Also shown is trimmer blade 23B, and notch 30A.

With reference now to FIG. 4A, a cutting plane 90 cutting a cross-section of canted razor blades 34, cutting edges 35A and 35B, and slotted opening 29 of razor blade encasement 25 are depicted. The cross-section is typical of all canted razor blades 34, all cutting edges 35A and 35B, and all slotted openings 29 of razor blade encasement 25, with the exceptions of cutting edge 35A on the left end of obverse side 26, and cutting edge 35B on the right end of obverse side 26, both of which are integral with their appropriate part of obverse side 26. Razor blade encasement 25A will have only cutting edges 35A of canted razor blades 34.

With reference now to FIG. 4B, the cross-section of canted razor blades 34 is depicted. The cross-sections of cutting edges 35A and 35B created by cutting plane 90 are also shown. In FIG. 4B, cutting edges 35A and 35B are shown as being hollow-ground sharpened. Note that direction line 99 is pointing in the correct direction for cutting edge 35A to slice beard or body hair, and that cutting edge 35B will not slice beard or body hair until razor blade encasement 25 is removed from encasement support 23, is turned upside down, and is re-inserted onto encasement support 23, with the encircled numeral 2 on obverse side 26 being then right-side up.

With reference now to FIG. 4C, the cross-sections of canted razor blades 34, the cross-sections of cutting edges 35A and 35B created by cutting plane 90 are depicted. In FIG. 4C, cutting edges 35A and 35B are shown as being taper-sharpened. Note that direction line 99 is pointing in the correct direction for cutting edge 35A to slice beard or body hair, and that cutting edge 35B will not slice beard or body hair until razor blade encasement 25 is removed from encasement support 23, is turned upside down, and is re-inserted onto encasement support 23, with the encircled numeral 2 on obverse side 26 being then right-side up.

With reference now to FIG. 5 a front view (obverse side 126) of razor blade encasement 125 is shown. The razor blade encasement 125 differs from razor blade encasement 25 in that its configuration of canted blades 134 is built with an assembly of multiple, parallel, individual blades 134, rather than being made from one flat piece of metal or other suitable material as in razor blade encasement 25. Razor blade encasement 125, other than parallel canted blades 134, is made of plastic or other suitable structural material, which lends itself to manufacture by 3-dimensional printing, as well as, and in addition to, conventional manufacturing methods. FIG. 5 displays multiple, canted, parallel, individual razor blades 134 that are affixed in place such as are found in current razor blade cartridges, with sharpened edges 135, and spaces 129 between blades 134. Spaces 129 and angle of cant of blades 134 are such that the upper parts or tops of sharpened edges 135 overlap the area sliced by the lower parts or bottoms of sharpened edges 135, to insure full shaving coverage of the area being sliced (shaved) when moving razor blade encasement 125 in the direction of arrow 99 during the act of shaving. Refer to vertical reference line 21-21 for visual confirmation of the overlap, and note that vertical reference line 21-21 is one line of an angle from which the angle of cant of blades 134 makes with the vertical.

Line 20-20 is a horizontal reference line. Line 22-22 designates the longitudinal axis of each razor blade 134, and is a reference line denoting the angle of cant between longitudinal axis 22-22 and vertical reference line 21-21.

Empty space 127, positioned on the right and left sides of canted razor blades 134 of encasement 125, extends between obverse side 126 of razor blade encasement 125 and front surface 42 of encasement support 23, as shown in FIG. 3A. Number 142 designates empty space behind and between canted razor blades 134 and front surface 42 of encasement support 23. (See FIG. 6).

According to one non-limiting embodiment, encasement 125 further includes a dog hole 44 that enables a razor user to remove razor blade encasement 125 using an extraction tool 46. See FIG. 14. Note that razor blade encasement 125 cannot be removed, turned upside down, and re-inserted on encasement support 23 for shaving, as is the case with razor blade encasement 25. The configuration of canted blades 134 as drawn prevents such use. Number 99 shows the direction in which to move the razor blade encasement in order to slice off body or facial hair when shaving.

With reference now to FIG. 6, a cross-section CS1 of razor blade encasement 125 is depicted, as defined by cutting plane CP1-CP1 shown in FIG. 5. In this configuration, the entire plastic razor blade encasement, except for the razor blades 134, has been constructed by a 3-dimension printer, or by conventional manufacturing methods of making plastic parts.

Identified are razor blade encasement 125, top curve 136, top retainer 138, insertion tab 130, cutting edge 135, canted razor blade 134, dog hole 44 (dashed lines) empty space 142, bottom retainer 139, and bottom curve 137. Front surface 42 of encasement support 23 is further depicted when the razor blade encasement 125 is mounted on encasement support 23.

Top retainer 138 and bottom retainer 139, together with front surface 42 (shown in parentheses) of encasement support 23, hold razor blade encasement 125 firmly in place on encasement support 23, requiring extraction tool 46 to safely pull the razor blade encasement off encasement support 23. Bottom curve 137 allows a smooth transition, when a user is shaving, to safely “roll” the canted razor blades 134 into an operative position.

The locations of dog holes 44 and empty space 142 relative to other parts of razor blade encasement 125 are also identified.

Handle 23A can be cast or 3-dimensionally printed so that razor blade encasement 125 can be made as an integral part of a complete shaving unit without becoming an encasement.

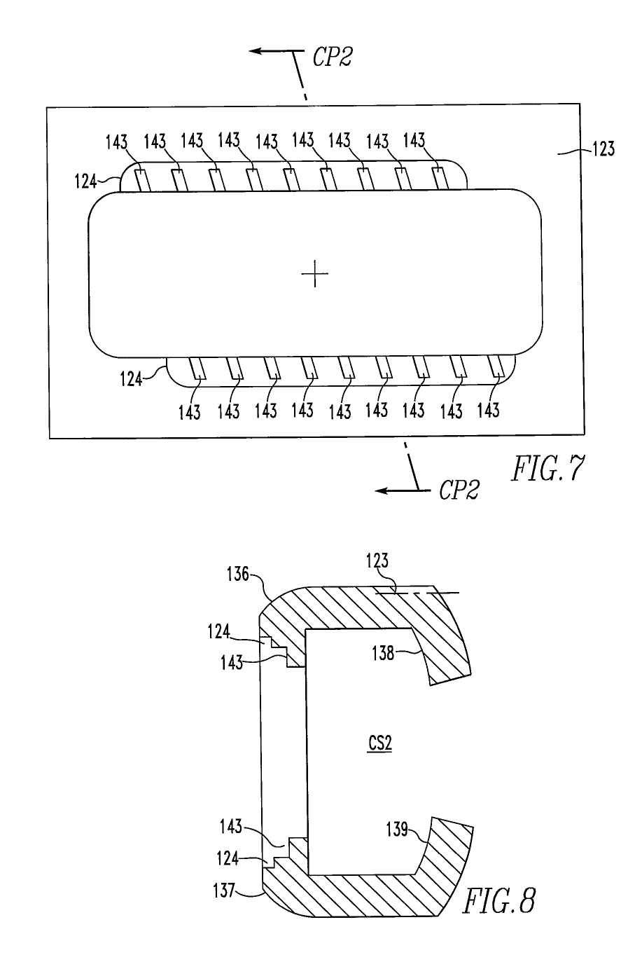

With reference now to FIG. 7, a razor blade encasement framework 123 is depicted, before individual razor blades 135 are inserted into locating notches 143. Locating notches 143 are located within sunken substructure 124, which is defined by FIGS. 7 and 8. Locating notches 143 are constructed to attain no less than an American Standards Association snug-fit classification (meaning no wiggle room) between them and insertion tabs 130 (See FIGS. 9 and 10) of canted razor blades 134. After all individual razor blades 134 are inserted into place in notches 143, 3-dimensional printing deposits finishing material over locating notches 143 in order to lock them into place, as shown in FIGS. 6 and 12. The depth of razor blades 134 is such as to allow the finishing material to cover locating notches 143, while allowing sharpened edges 135 to extend beyond the finishing material, a distance sufficient to allow sharpened edges 135 to accomplish the slicing assignment. The finished product appears as a front view in FIG. 5. An alternate method of locking canted razor blades 134 in place is to provide the fitted locking piece 131, as shown in FIGS. 13 and 13A, and cement it in place with an appropriate adhesive.

With reference now to FIG. 8, a cross-section CS2 of razor blade encasement framework 123 is depicted, as defined by cutting plane CP2-CP2, shown in FIG. 7. Cutting plane CP2 affords both a profile view (See FIG. 8) of razor blade encasement 125, but also notes the location of its various parts and their relationship to each other. Identified are top curve 136, top retainer 138, bottom curve 137, and bottom retainer 139. Also shown is the depth of the indentation of sunken substructure 124, and the depth of the indentations of locating notches 143.

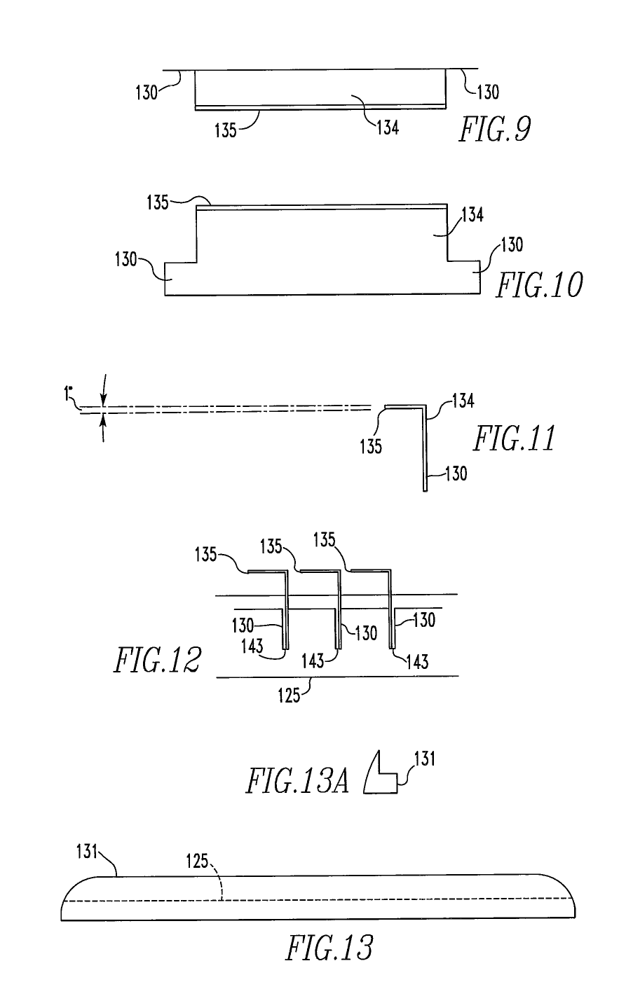

With reference to FIGS. 9-12, views of razor blade 134 are depicted. FIG. 9 displays a top view of razor blade 134. Also shown are cutting edge 135, and insertion tabs 130, which are snug-fit into locating notches 143. FIG. 10 displays a side view of razor blade 134, with cutting edge 135, and insertion tabs 130. FIG. 11 displays an end view of razor blade 134. Cutting edge 135 is also identified. Note that the segment of razor blade 134 containing cutting edge 135 is bent upwards a maximum of one degree, or a maximum equal to the thickness of the blade. FIG. 12 illustrates the placement of insertion tabs 130 into locating notches 143, and either the addition of material 80, or the placement of locking piece 131. The width of locking piece 131 is equal to the length of the amount of extension that insertion tabs 130 extend outward from the main body of razor blade 134.

With reference to FIGS. 13 and 13A, a top view of locking piece 131 is depicted. Razor blade encasement 125 is located beneath the locking piece 131 and is depicted with the dashed line that locates the right angle as shown in FIG. 13A. FIG. 13A displays an end view of locking piece 131, which fits into the sunken substructure 124. (See FIG. 8).

With reference to FIG. 14, the extraction tool 46 is depicted. Razor blade encasements 25, 25A, and 125 may be removed safely from encasement support 23 with the help of extraction tool 46. Hook 49 at the end of hook support 50 of extraction tool 46 is inserted into dog hole 44. The operator's forefinger and middle finger are bent around the flat finger support 47 attached to round handle 48, which is held by the operator's hand. Razor blade encasement 25, or 125, then is pulled off encasement support 23.

With reference to FIGS. 15-17, the slicing action of the razor blades 34, 134 on facial or body hair is more specifically described. As is shown in FIG. 15, cutting edges 35A and 35B are located on canted blades 34 of razor blade encasement 25. Cutting edges 35A are located on canted razor blades 34 of razor blade encasement 25A, and cutting edges 135 of canted razor blades 134 on razor blade encasement 125. Position A shows a cutting edge 35A, or 135, in contact with a protruding hair shaft 80. Arrow 81 indicates the direction of travel of cutting edge 35A. Position B shows cutting edge 35A after it has advanced past protruding hair shaft 80, traveling in the direction of arrow 81. The circle 82 shown in dashed lines indicates that the protruding hair shaft 80 has been sliced off.

FIG. 16 illustrates the allocation of slicing/shaving force of cutting edges 35A and 35B of canted razor blades 34 of razor blade encasements 25 and 25A, and cutting edges 135 of razor blade encasement 125, when the angle θ made by line AB with vertical line AG is 10 degrees. This illustration uses an XY coordinate system. Let line AB represent a canted blade 34, and L the length of that canted blade 34 such that AB=L. Let L=1. Vertical line AG is parallel to the YY axis. Let vertical line AG represent slicing/shaving force F, moving from A to G. Slicing/shaving force F can be in English or metric units. The projection of AB on OY is represented by y. The projection of AB on OX is represented by x. The angle BAG (θ) deviates from the vertical line AG by 10 degrees. The slicing/shaving force F along L (L=1) is y=L cosine θ=0.9848 units of force. The lateral slicing/shaving force F, representing the amount of chopping force, moving in the direction from D to C, is x=sine θ=0.1637 times units of force. Clearly, much more slicing/shaving force F is directed to slice off facial or body hair than is used to chop the hair. If angle θ were 45 degrees, then the value of both sine θ and cosine θ would be equal at 0.6061 times units of force, which means that the amount of slicing/shaving force would be equal to the amount of chopping force. Conversely, if angle BAG is 10 degrees, then angle GBA is 80 degrees, y=L=sine θ=0.9848 units of force, and x=cosine θ=0.1637 times units of force.

FIG. 17 illustrates the allocation of slicing/shaving force of cutting edges 35A and 35B of canted razor blades 34 of razor blade encasements 25 and 25A, and cutting edges 135 of razor blade encasement 125, if the angle θ made by line AB with vertical line AG is greater than 45 degrees. This illustration uses an XY coordinate system in which angle BAG (θ)=60 degrees. Line AB represents a canted blade 34, and L the length of a canted blade 34 such that AB=L and L=1. Vertical line AG is parallel to the YY axis and represents slicing/shaving force F, moving from A to G. Slicing/shaving force F can be in English or metric units. The projection of AB on OY is represented by y. The projection of AB on OX is represented by x. The angle BAG (θ) deviates from the vertical line AG by 60 degrees.

The downward slicing/shaving force F along L (L=1) is y=L cosine θ=0.5000 times units of force. The lateral slicing/shaving force F, representing the amount of chopping force, moving in the direction from D to C, is x=sine θ=0.8660 times units of force, resulting in more chopping force than slicing/shaving force F. If angle BAG were 90 degrees, there would be zero percent slicing force and one-hundred percent chopping force exerted on AB, which represents cutting edge 35 or cutting edge 65.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A razor blade cartridge comprising:
a housing; and
at least one canted razor blade supported by or formed within the housing.

2. The cartridge of claim 1, wherein
the housing comprises a top curved portion, a flat section, and a bottom curved portion formed by bending a metal piece; and
the at least one canted razor blade is formed in the housing by cutting two or more slotted openings in linear parallel alignment in a longitudinal direction of a center section of the metal piece such that at least one razor blade having a first and a second sharpened cutting edge is formed between each set of slotted openings,
wherein the slotted openings and the at least one razor blade are canted with respect to a longitudinal axis of the metal piece.

3. The cartridge of claim 2 wherein the slotted openings and the at least one razor blade are canted at an angle that is greater than 45 degrees with respect to the longitudinal axis of the metal piece.

4. The cartridge of claim 3, wherein the slotted openings and the at least one razor blade are canted at an angle of between about 70 and 89 degrees with respect to the longitudinal axis of the metal piece.

5. The cartridge of claim 2, further comprising a plurality of razor blades canted with respect to the longitudinal axis of the metal piece,
wherein the plurality of canted razor blades area aligned to overlap such that a vertical line running downward from a highest point of a cutting edge of one razor blade overlaps a lower point of a cutting edge of an adjacent razor blade.

6. The cartridge of claim 2 wherein the sharpened cutting edges are hollow-ground sharpened or tapered.

7. The cartridge of claim 2 wherein the sharpened cutting edges of the at least one razor blade are tilted outward by not more than 1 degree or not more than a thickness of the razor blade so that when brought in contact with a surface to be shaved, the cutting edges of the razor blade contacts the surface before any other portion of the housing.

8. The cartridge of claim 2 further comprising one or more trimming blocks having a blade running parallel to the longitudinal axis of the cartridge for trimming longer hair such as sideburns of a user.

9. The cartridge of claim 8 wherein the trimming block is brought into contact with a surface to be shaved by placing the top or bottom curved portion of the metal piece on a surface and rotating the cartridge toward the surface to be shaved thereby bringing the blade of the trimming block in contact with the surface to be shaved.

10. A razor and cartridge having one or more canted razor blades comprising:
a cartridge having:
a metal piece bent to form a housing having a curved top portion, a flat section, and a curved bottom portion; and
two or more slotted openings cut in linear parallel alignment in a longitudinal direction of a center section of the metal piece and having a sharpened edge such that a razor blade having a first and a second sharpened cutting edge is formed between each set of slotted openings,
wherein the slotted openings are canted with respect to the longitudinal axis of the metal piece thereby forming one or more canted razor blades;
an encasement support which is received within a cavity formed by the curved top and curved bottom portions of the metal piece of the cartridge such that the cartridge surrounds and is supported by the encasement support; and
a handle extending from the encasement support allowing a user to hold and guide the razor while in use.

11. The razor of claim 10 further comprising an axle located between the encasement support and the handle for allowing the cartridge to pivot during shaving.

12. The razor of claim 10 wherein the cartridge is removable from the encasement support.

13. The razor of claim 12 wherein the cartridge is capable of being rotated 180 degrees and reinserted to the encasement support in an upside down orientation so that, in use, the second sharpened cutting edge of the razor blade is used for shaving.

14. A cartridge for a razor for holding one or more razor blades in a canted orientation comprising:
a frame having a front face, a rear face, a top end, and a bottom end, and a sunken structure formed within the front face; and
one or more sets of locating notches on the front face of the frame located adjacent to the sunken structure, wherein each set of two notches is configured to hold the razor blade across the sunken structure in a canted position with respect to a longitudinal axis of the frame.

15. The cartridge of claim 14 wherein the one or more sets of locating notches are configured to hold the razor blade at an angle of between about 70 and 89 degrees with respect to the longitudinal axis of the cartridge.

16. The cartridge of claim 14 wherein the one or more sets of locating notches are configured to hold one or more razor blades in parallel and linear alignment forming equidistant spaces between the razor blades.

17. The cartridge of claim 16 wherein the equidistant spaces between the razor blades are wider than a width of the razor blades.

18. The cartridge of claim 14 wherein the one or more sets of locating notches are configured to hold the razor blades such that a cutting edge of the razor blade is bent upwards a maximum of one degree or a maximum equal to a thickness of the razor blade.

19. The cartridge of claim 14 further comprising one or more razor blades having a top end and a bottom end wherein the top end and bottom end of the razor blade are connected to corresponding locating notches of the frame.

20. The cartridge of claim 19 further comprising a cementing locking piece for holding in a sealing engagement of the one or more razor blades to the locating notches.
